(19) United States
(12) Patent Application Publication
(10) Pub. No.: US 2025/0119072 A1
(43) Pub. Date: Apr. 10, 2025

(54) VIBRATORY ACTUATOR, MOVING OBJECT HAVING THE SAME, MOVING OBJECT CONTROL SYSTEM, AND VACUUM APPARATUS

(71) Applicant: CANON KABUSHIKI KAISHA, Tokyo (JP)

(72) Inventors: SATOSHI TSUCHIYA, Saitama (JP); SATORU KITAJIMA, Tokyo (JP); YUKI ODA, Kanagawa (JP)

(21) Appl. No.: 18/909,208

(22) Filed: Oct. 8, 2024

(30) Foreign Application Priority Data
Oct. 10, 2023 (JP) 2023-175146
Jul. 31, 2024 (JP) 2024-124476

(51) Int. Cl. H02N 2/02; B64G 1/10; B64G 1/24

(52) U.S. Cl. CPC H02N 2/026; B64G 1/244; B64G 1/10

(57) ABSTRACT

A vibratory actuator capable of improving the abrasion resistance to enable stable driving in a vacuum environment such as outer space or a vacuum apparatus. There is provided a vibratory actuator, wherein a contact member and a vibrating member relatively move by a vibration of the vibrating member, wherein a flat portion and a raised portion having a parietal portion and a wall portion are integrally formed on an elastic member, where each edge or an entire circumference of the parietal portion is supported by the wall portion, wherein the parietal portion is provided with a friction member, different from the elastic member, to come into contact with the contact member, wherein the friction member is a sphere or column, and wherein the friction member is supported by an inclined surface formed on the parietal portion.

### BACKGROUND

### Field

The present disclosure relates to a vibratory actuator and a moving object having the vibratory actuator.

### Description of the Related Art

A vibratory actuator has been practically used as an automatic focus driving actuator for a photographic lens of a single-lens reflex camera because of a slow speed, a high thrust, and other features. In recent years, applications of vibratory actuators to apparatuses used under unusual circumstances have also been expected. Examples of applications include artificial satellites used in outer space and vacuum apparatuses used for production and analysis. These apparatuses involve actuator operations in vacuum as unusual circumstances.

Japanese Patent No. 6938218 discusses a linear type vibratory actuator including a vibrating member formed of a rectangular elastic member, and two different raised portions on the surface of the elastic member. A stainless sintered body with an immersed resin is disposed as a friction member at the leading end of each raised portion. With this vibratory actuator, a contact member is brought into pressure contact with the leading ends of the raised portions, and a predetermined alternating-current (AC) voltage is applied to an electromechanical energy conversion element to activate two different out-of-plane bending vibration modes. The activated vibration generates an elliptic motion at the leading end of the raised portions, and the elliptic motion and friction cause a relative movement between the vibrating member and the contact member.

In a vacuum environment such as outer space or a vacuum apparatus, the vibratory actuator discussed in Japanese Patent No. 6938218 provides remarkably low thermal diffusion to vacuum of frictional heat occurring on the friction plane between the vibrating member and the contact member, and thus, the frictional heat remains. Further, in vacuum where almost no oxygen and moisture exist, no metal oxide layer functioning as a protective layer is formed on the above-described friction plane. This may possibly cause the adhesion to the friction plane. Therefore, a large amount of abrasion occurs on the friction surface of the vibrating member to degrade the frictional characteristics, possibly degrading the drive performance.

### SUMMARY

The present disclosure is directed to providing a vibratory actuator having a sufficient abrasion resistance to enable stable driving even in a vacuum environment such as outer space or a vacuum apparatus.

According to some embodiments, there is provided a vibratory actuator including a vibrating member having a rectangular elastic member and an electromechanical energy conversion element, and a contact member in contact with the elastic member, wherein the contact member and the vibrating member relatively move by a vibration of the vibrating member, wherein a flat portion and a raised portion having a parietal portion and a wall portion are formed on the elastic member, where each edge or an entire circumference of the parietal portion is supported by the wall portion, wherein the parietal portion is provided with a friction member, different from the elastic member, to come into contact with the contact member, wherein the friction member is a sphere or column, and wherein the friction member is supported by an inclined surface formed on the parietal portion.

Further features of the present disclosure will become apparent from the following description of exemplary embodiments with reference to the attached drawings.

### BRIEF DESCRIPTION OF THE DRAWINGS

FIG. 1 is a perspective view illustrating an overall configuration of a vibratory actuator according to a first exemplary embodiment of the present disclosure.

FIG. 2 is a fragmentary perspective view illustrating the vibratory actuator in FIG. 1.

FIG. 3 is a perspective view illustrating configurations of a vibrating member and a retaining member in FIG. 1.

FIG. 4 is a fragmentary perspective view illustrating a vibrating member and a retaining member in FIG. 3.

FIG. 5 is a perspective view illustrating a vibration mode for activating the vibrating member of the vibratory actuator in FIG. 1.

FIG. 6 is a cross-sectional view illustrating the vibrating member in FIG. 3.

FIG. 7 is a cross-sectional view illustrating a part of the vibrating member in FIG. 3.

FIG. 8 is a fragmentary sectional view illustrating a part of the vibrating member in FIG. 3.

FIG. 9 is another fragmentary sectional view illustrating a part of the vibrating member in FIG. 3.

FIG. 10 is a cross-sectional view illustrating a part of a first modification of the vibrating member according to the first exemplary embodiment.

FIG. 11 is a cross-sectional view illustrating a part of a second modification of the vibrating member according to the first exemplary embodiment.

FIG. 12 is a cross-sectional view illustrating a part of a third modification of the vibrating member according to the first exemplary embodiment.

FIG. 13 is a perspective view illustrating a fourth modification of the vibrating member according to the first exemplary embodiment.

FIG. 14 is a cross-sectional view illustrating a part of the vibrating member in FIG. 13.

FIG. 15 is another cross-sectional view illustrating a part of the vibrating member in FIG. 13.

FIG. 16 is a schematic view illustrating a moving object having an airframe mounted with a vibratory actuator.

FIG. 17 is a schematic view illustrating a vacuum apparatus mounted with a vibratory actuator.

### DESCRIPTION OF THE EMBODIMENTS

Various exemplary embodiments, features, and aspects of the present disclosure will be described in detail below with reference to the accompanying drawings.

“Vacuum” refers to the air pressure of any one of low vacuum (lower than the atmospheric pressure, equal to or higher than 100 pascals (Pa)), medium vacuum, high vacuum, ultra high vacuum, or extra high vacuum (lower than 1×10⁻⁹ Pa) conforming to Japanese Industrial Standards (JIS) Z8126-1. The shapes of a sphere and column include not only a perfect sphere and circle but also an ellipsoid close to a sphere and a cylinder having an elliptic cross-section, not departing from the spirit and scope of the present disclosure.

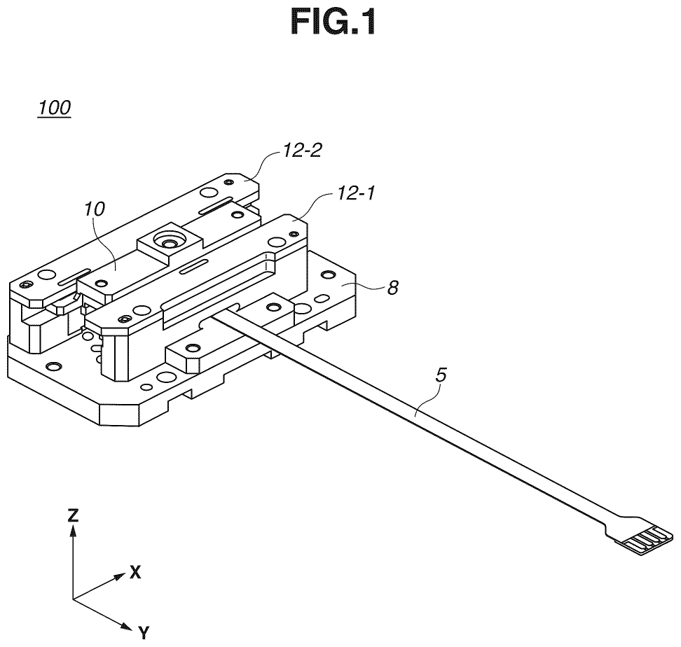

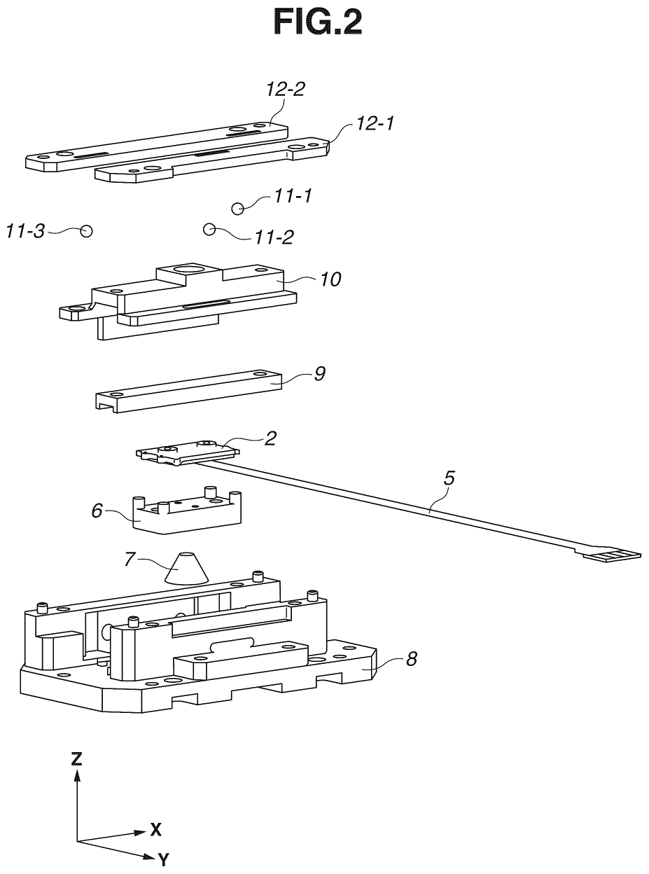

FIG. 1 is a perspective view illustrating an overall configuration of a vibratory actuator 100 according to a first exemplary embodiment of the present disclosure. FIG. 2 is a fragmentary perspective view illustrating the vibratory actuator 100 in FIG. 1. The moving direction of the contact member 9 is the X direction, the pressurizing direction is the Z direction, and the direction perpendicular to the X-and the Z directions is the Y direction.

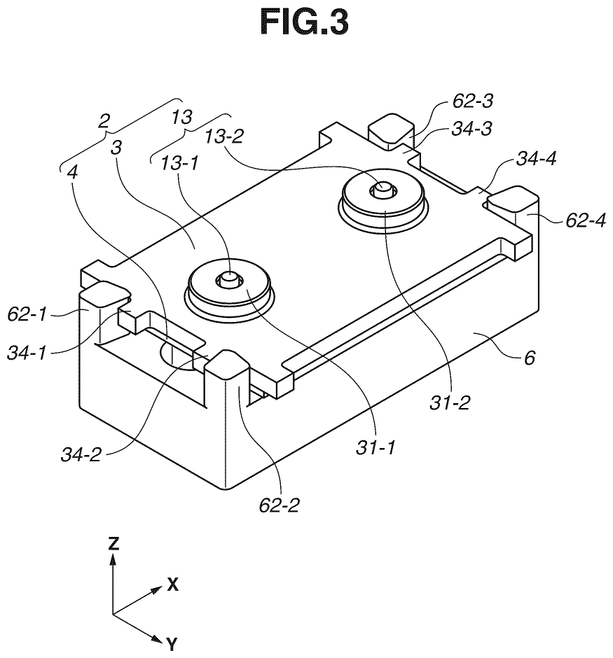

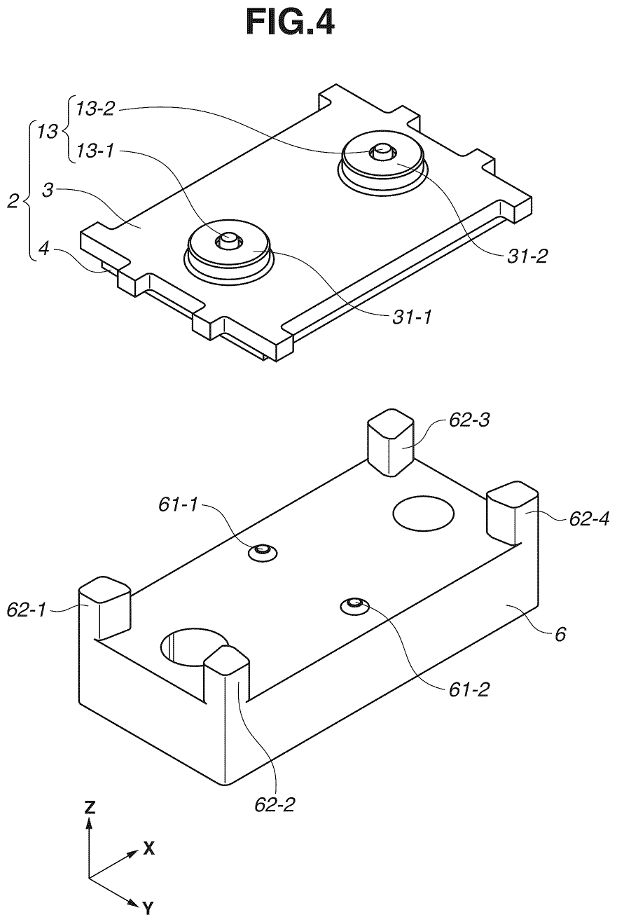

FIG. 3 is a perspective view schematically illustrating configurations of a vibrating member 2 and a retaining member 6 in FIG. 1. FIG. 4 is a fragmentary perspective view illustrating the vibrating member 2 and the retaining member 6 in FIG. 3. Referring to FIGS. 3 and 4, a flexible printed circuit board 5 is not illustrated.

The vibratory actuator 100 includes the vibrating member 2, 102 having an electromechanical energy conversion element 4, 104 and an elastic member 3, 103. The vibrating member 2 retained by the retaining member 6 is in contact with the contact member 9. The vibrating member 2 and the contact member 9 are configured to be relatively movable by the vibration generated by the vibrating member 2.

As a specific example of a configuration, the vibratory actuator 100 includes the contact member 9 in pressure contact with the elastic member 3, and the retaining member 6 having two different raised portions 61 (61-1 and 61-2) as contact portions in contact with nodes on the side opposite to the side facing the contact member 9.

The vibrating member 2 includes the elastic member 3, two different friction members 13 (13-1 and 13-2), and the electromechanical energy conversion element 4, and is supplied with power from a power source (not illustrated) via the flexible printed circuit board 5. The electromechanical energy conversion element 4 is integrally formed with one main surface (back surface in FIG. 3) of the elastic member 3 via an adhesive agent. The electromechanical energy conversion element 4 is provided with the flexible printed circuit board 5 on the side opposite to the facing plane between the electromechanical energy conversion element 4 and the elastic member 3. The flexible printed circuit board 5 and the electromechanical energy conversion element 4 are electrically connected with each other.

The elastic member 3 is provided with two different raised portions 31 (31-1 and 31-2) on the side opposite to the facing plane between the elastic member 3 and the electromechanical energy conversion element 4. Each of the raised portions 31 has a wall portion backed up by the flat portion of the elastic member 3, and a parietal portion supported by the wall portion. The parietal portion has edges and is supported on each edge or over the entire circumference by the wall portion, providing a structure that is robust against the pressing force in the Z direction. The following example is based on a structure in which the parietal portion is supported over the entire circumference by the wall portion.

The parietal portions of the two raised portions 31 are provided with the friction members 13 (13-1 and 13-2) as different members. Although FIG. 3 illustrates the two raised portions 31 (31-1 and 31-2), the relative movement between the vibrating member 2 and the contact member 9 is possible by at least one raised portion 31.

The elastic member 3 is made of a metal material having a small vibration attenuation. The material will be specifically described below. A piezoelectric element can be suitably used as the electromechanical energy conversion element 4 and is bonded to the elastic member 3 with an adhesive agent. The piezoelectric element as the electromechanical energy conversion element 4 is made of a plate-like piezoelectric ceramic provided with electrodes having a predetermined shape formed on both sides thereof. A drive voltage (alternating current (AC) voltage) having a predetermined frequency from the flexible printed circuit board 5 is applied to the electrodes of the electromechanical energy conversion element 4.

Referring to FIG. 3, the retaining member 6 for retaining the vibrating member 2 is disposed below the vibrating member 2. A pressurization spring 7 is applicable as a member for pressurizing the vibrating member 2 to the contact member 9. The pressurization spring 7 pressurizes the retaining member 6 in the Z direction in FIG. 3, and the reactive force received by the pressurization spring 7 is received by a base 8.

Preferably, a conical coil spring is used as the pressurization spring 7 to downsize the vibratory actuator 100 in the Z direction. The coil shape is illustrated in a simplified way. The pressurization spring 7 applies a predetermined pressurizing force (several hundred gf according to the present exemplary embodiment) to the vibrating member 2.

A method for positioning the vibrating member 2 in the X and Y directions will be described below. Loose-fit portions 61-1, 61-2, 61-3, and 61-4 disposed on the retaining member 6 fit into four extended portions 34-1, 34-2, 34-3, and 34-4 of the elastic member 3 extending in the X direction. This structure prevents the vibrating member 2 from moving relative to the pressurization spring 7 in the X and Y directions without excessively disturbing the vibration in the Z direction. The loose-fit portions 61 loosely support the four extended portions 34 at the four corners of the vibrating member 2, providing a robust support structure.

As illustrated in FIG. 2, the contact member 9 is retained by a contact member holder 10. The side surface of the contact member holder 10 along the longitudinal direction is provided with two different ball rails 12-1 and 12-2 for holding three different balls 11-1, 11-2, and 11-3. In this state, by fixing the ball rails 12-1 and 12-2 to the base 8, the integrated object of the contact member 9 and the contact member holder 10 can move in the X direction relative to parts other than the integrated object. In particular, the vibration of the vibrating member 2 in contact with the contact member 9 causes the vibrating member 2 and the integrated object (the contact member 9 and the contact member holder 10) to relatively move along the X direction in FIG. 2. Attaching an output transfer unit having a desired shape to the contact member holder 10 enables transmitting the output to the outside, allowing the vibratory actuator 100 to exhibit its actuator function.

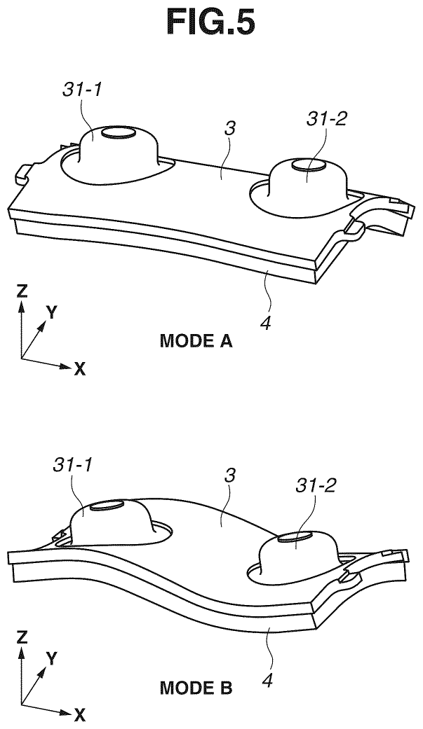

The vibration mode activated by the vibrating member 2 will be described below with reference to FIG. 5. The vibrating member 2 in FIG. 5 is configured as discussed in Japanese Patent No. 6938218 and has the same operating principle as the vibrating member 2 according to the present exemplary embodiment. According to the present exemplary embodiment, an AC voltage is applied to the electromechanical energy conversion element 4 via the flexible printed circuit board 5. This activates an out-of-plane bending vibration with two different vibration modes on the vibrating member 2 to generate a combined vibration of these vibrations. These vibration modes (vibration modes A and B described below) cause a vibration between adjacent nodes.

The vibration mode A (first vibration mode) is a primary out-of-plane bending vibration mode in which two different nodes appear in parallel with the X direction as the longitudinal direction of the vibrating member 2, across the two raised portions. The vibration in the vibration mode A displaces the two raised portions in the Z direction as the pressurization direction. The vibration mode B (second vibration mode) is a secondary out-of-plane bending vibration mode in which three different nodes appear approximately in parallel with the Y direction as the lateral direction of the vibrating member 2. The vibration in the vibration mode B displaces the two raised portions in the X direction. The vibration mode B is not limited to the secondary vibration mode but can be an N-order vibration mode (N is 1, or 3 or a larger integer).

Combining the vibrations in the vibration modes A and B causes an elliptic or circular motion of the two raised portions 31-1 and 31-2 in the ZX plane. Bringing the contact member 9 into pressure contact with the two raised portions 31-1 and 31-2 generates a frictional force in the X direction. This force generates a driving force (thrust) that enables either one of the vibrating member 2 or the contact member 9 to move relative to the other. According to the exemplary embodiment, the contact member 9 moves in the X direction since the vibrating member 2 is retained with a technique to be described below. In addition, the vibrating member 2 may be configured to move in the X direction by fixing the position of the contact member 9 with a predetermined fixing member.

To efficiently drive the vibratory actuator 100, the vibrating member 2 needs to be supported without hampering the vibration (displacement) of the two vibration modes for activating the vibrating member 2.

To accomplish this, desirably, the vicinities of the nodes of these two vibration modes are supported. For this reason, to pressurize and retain common nodes of the two vibration modes activated by the vibrating member 2, the two raised portions 61-1 and 61-2 are disposed on the retaining member 6 for retaining the vibrating member 2 as illustrated in FIG. 4.

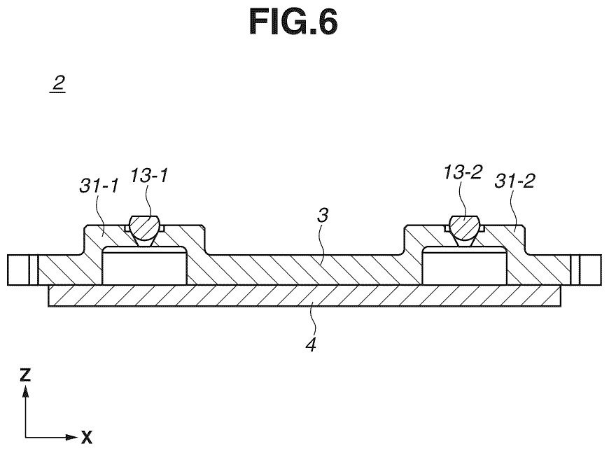

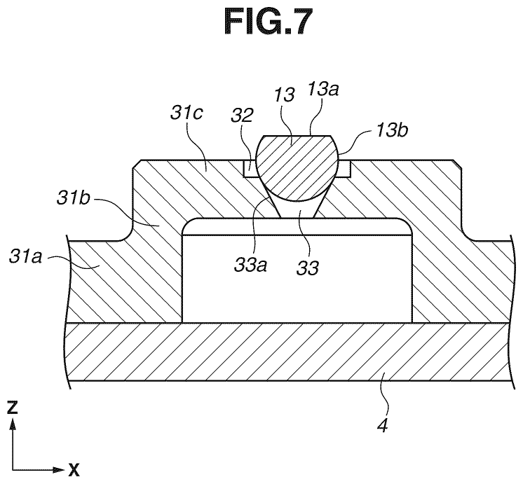

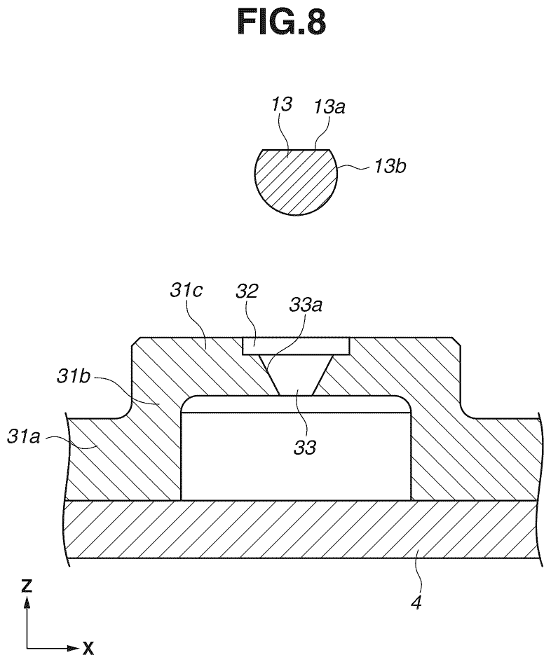

Detailed configurations and materials of the elastic member 3 and the friction members 13 will be described below with reference to FIGS. 6, 7, and 8. FIG. 6 is a cross-sectional view schematically illustrating the vibrating member 2 in FIG. 3. FIG. 7 is a cross-sectional view schematically illustrating a part of the vibrating member 2 in FIG. 3. FIG. 8 is a fragmentary sectional view illustrating the vibrating member 2 in FIG. 7.

The configuration of the raised portions 31 is not limited. However, as a preferable example, the raised portions 31 may be hollow raised portions integrally formed with the flat portion 31a of the elastic member 3 through press working or cutting process of the plate material configuring the elastic member 3. As another example, other members may be prepared as the raised portions 31 and disposed by welding or adhesion.

Each of the raised portions 31 is formed of a cylindrical wall portion 31b, and a disk portion 31c as the parietal portion of which the outer circumferential side is supported by the wall portion 31b. The disk portion 31c has a thickness providing a spring property of being deformed in the Z direction by a Z-direction load when in contact with the contact member 9.

As illustrated in FIG. 7, a first recessed portion 32 having a cylindrical shape is formed as a concave on the disk portion 31c at the center of the disk portion 31c, and a second recessed portion 33 having a truncated cone shape is formed on the bottom surface of the first recessed portion 32 so as to penetrate the disk portion 31c. The second recessed portion 33 has a truncated cone shape with which the diameter decreases along the Z direction from the first recessed portion 32. Each of the friction members 13 (13-1 and 13-2) having an approximately spherical shape comes into contact with an inclined surface 33a as a side wall of the second recessed portion 33 having a truncated cone shape, in an approximately circumferential form, on a curved surface 13b. The friction member 13 is fixed by an adhesive agent (not illustrated). The side wall of the second recessed portion 33 may partly form an inclined surface and partly form a cylindrical shape.

By bringing the inclined surface 33a having a truncated cone shape of the second recessed portion 33 into contact with the curved surface 13b of the friction member 13, the friction member 13 and the disk portion 31c can be accurately positioned in the X, Y, and Z directions. The friction member 13 can be firmly fixed since the gap between the first recessed portion 32 and the second recessed portion 33 is filled with an adhesive agent. The friction member 13 can be more firmly fixed since the diameter of the first recessed portion 32 is larger than the friction member 13, providing a pool of the adhesive agent. Since the first recessed portion 32 and the second recessed portion 33 are disposed on the disk portion 31c, the adhesive agent drops in the adhesive agent pool at the time of bonding. This enables preventing the adhesive agent from overriding the friction member 13. This makes it possible to avoid contact between the unhardened adhesive agent and the contact member 9. The metal material configuring the disk portion 31c has a low Young's modulus, the adhesive agent has a small influence on the spring property of the disk portion 31c. Therefore, the adhesive agent may protrude from the first recessed portion 32 and the second recessed portion 33 as long as the adhesive agent does not come into contact with the contact member 9. This configuration enables firmly fixing the friction members 13 with high accuracy and improving the frictional driving force to the contact member 9 of the vibrating member 2, thus achieving efficient and stable driving even in a vacuum environment.

The friction member 13 has an approximately spherical shape formed by cutting a part of a spherical shape. The cross section of the friction member 13 is a friction surface 13a that comes into contact with the contact member 9. Since the friction surface 13a is a flat surface having a predetermined area, the friction member 13 and the contact member 9 come into surface contact, not point contact, with each other, thus reducing the contact surface pressure and abrasion.

The contact state between the friction surface 13a and the contact member 9 constantly changes while the vibratory actuator 100 is being driven. In this change process, the surface contact between the friction surface 13a and the contact member 9 on a larger area enables further improving the abrasion resistance. Since a pressurizing force is applied to the friction surface 13a in the Z direction by the contact member 9, the friction surface 13a serves as a loading point, and the disk portion 31c bends in the Z direction. Since the disk portion 31c has a structure supported at its opposite ends (cylinder support structure) in which the outer circumferential portion is supported by the cylindrical wall portion 31b, the friction surface 13a is displaced in the Z direction while keeping in parallel with the XY plane.

This allows the approximately entire surface of the friction surface 13a to come into contact with the contact member 9 in the deformation process of the disk portion 31c, thus reducing the contact surface pressure and abrasion. These effects improve the abrasion resistant and achieve stable driving. In particular, the above-described configuration has large effects in a vacuum environment where an issue of the abrasion resistant becomes noticeable.

The material of the elastic member 3 will be described below. Preferably, the elastic member 3 has high processibility because of its complicated shape. Materials having a high Vickers hardness (HV) are difficult to process and thus not suitable for the elastic member 3. Preferably, the material of the elastic member 3 has a low Vickers hardness. To achieve stable driving in a vacuum environment by reducing interferences by electron beams in a vacuum apparatus and reducing magnetic interferences with other apparatuses in an artificial satellite, preferably, the elastic member 3 is made of a nonmagnetic material. Examples metal materials satisfying these conditions include aluminum alloys (about HV120 or less), brasses (about HV160 or less), and austenitic stainless steels (about HV200 or less). The above-described Vickers hardness (HV) values are representative values and not limited thereto.

The material of the friction member 13 will be described below. Since the friction member 13 is subjected to frictional driving while the friction surface 13a is in contact with the contact member 9, preferably, the material of the friction member 13 has a high abrasion resistance and a high friction coefficient. Since the abrasion resistance is largely affected by the material of the mating member, the abrasion resistance has a correlation with the Vickers hardness (HV) although there is no definite index. Since the abrasion resistance tends to be higher with a higher Vickers hardness, preferably, the friction member 13 is made of a material having a high Vickers hardness. On the other hand, since good processibility is demanded of the elastic member 3, preferably, the material of the elastic member 3 has a low Vickers hardness. Therefore, preferably, the Vickers hardness of the friction member 13 is higher than that of the elastic member 3.

Examples of usable materials of the friction member 13 include hardened steel materials having a high Vickers hardness, nitriding-treated steel materials, ceramics, and cemented carbides. However, usable materials are not limited thereto. The Vickers hardness of the friction member 13 needs to be higher than that of the elastic member 3. Examples of usable materials include glasses, nickel alloys, cobalt alloys, and cermets.

Applicable hardened steel materials include martensite-based stainless steel SUS440C and SUS420J2 and high-carbon chromium bearing steel material SUJ2 having a Vickers hardness of about HV600 to HV800. Applicable nitriding-treated steel materials include stainless steels and other steel materials including austenitic steel materials having a Vickers hardness of about HV800 to HV1200. Applicable ceramics include aluminum, zirconia, silicon nitride, and silicon carbide having a Vickers hardness of about HV1000 to HV2000. Applicable cemented carbides include tungsten carbide having a Vickers hardness of about HV1500 to HV2000 using cobalt and nickel as a bonding material. Applicable glasses include soda glass having a Vickers hardness of about HV500, quartz having a Vickers hardness of about HV1000, and sapphire and ruby having a Vickers hardness of HV2000 or higher. The above-described Vickers hardness (HV) values are representative values and the present disclosure is not limited thereto.

To improve both the processibility of the elastic member 3 and the abrasion resistant of the friction member 13, preferably, the Vickers hardness of the friction member 13 is at least twice that of the elastic member 3. More preferably, the Vickers hardness of the friction member 13 is at least three times that of the elastic member 3.

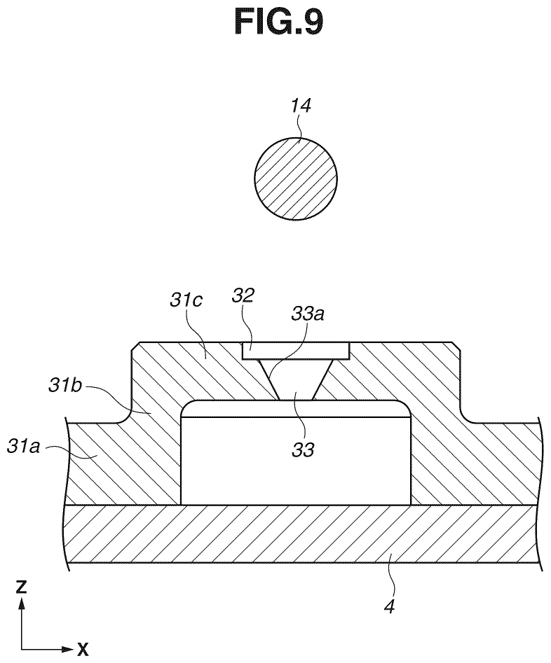

FIG. 9 is a fragmentary perspective view illustrating a part of the vibrating member 2 before the friction surface 13a is formed. The friction member 13 is a spherical precision ball 14 before the friction surface 13a is formed. Preferably, the precision ball 14 is one used for ball bearings, physics and chemistry experimental tools, and ball point pens. The precision ball 14 to be used has a high Vickers hardness, a high abrasion resistance, and a high dimensional accuracy.

A method for forming the friction member 13 having the friction surface 13a in surface contact with the contact member 9 will be described below. The vibrating member 2 is produced with the spherical precision ball 14 bonded to the elastic member 3 and built in the vibratory actuator 100. Then, the vibratory actuator is driven. Thus, the precision ball 14 is worn by friction with the contact member 9 in a short time. Accordingly, the contact state changes from the point contact to the surface contact, and the friction member 13 having the friction surface 13a is formed. In this case, making the Vickers hardness of the contact member 9 higher than that of the friction member 13 enables shortening the forming time of the friction surface 13a while reducing the abrasion of the contact member 9.

After the precision ball 14 is bonded to the elastic member 3, a part of the precision ball 14 may be scraped through a lapping process to form the friction surface 13a.

The contact position between the contact member 9 and the vibrating member 2 moves in the X direction by the drive of the vibratory actuator 100. Therefore, the friction surfaces 13a of the contact member 9 and the vibrating member 2 are formed as lines having a predetermined width along the X direction. If the abrasion depth of the friction surface 13a of the contact member 9 largely differs according to the position, the friction state changes according to the position relative to the vibrating member 2, resulting in uneven drive performance of the vibratory actuator 100. To prevent the uneven drive performance, preferably, the abrasion depth of the friction surface 13a of the contact member 9 is prevented as far as possible. To reduce the abrasion of the contact member 9, preferably, the contact state of the friction member 13 of the vibrating member 2 is immediately shifted from the point contact to the surface contact through the abrasion in the initial drive stage. Therefore, preferably, the abrasion resistance of the friction member 13 is lower than that of the contact member 9, i.e., the friction member 13 is easy to be worn. Preferably, the Vickers hardness of the contact member 9 is higher than that of the friction member 13. Preferably, the elastic member 3, the friction member 13, and the contact member 9 have a higher Vickers hardness in this order. Examples of usable materials of the contact member 9 include nitriding-treated steel materials such as stainless steels, ceramics, and metal materials coated with ceramics.

Preferably, at least either one of the friction member 13 or the contact member 9 is mainly made of a nonmetal inorganic material. More preferably, both members are made of a nonmetal inorganic material. Preferably, at least either one of the friction member 13 or the contact member 9 is mainly made of a nonmetal inorganic material, resulting in an abrasion form in which a metal oxide film formed by friction is not used as a protection film. More preferably, at least the friction member 13 contains a nonmetal inorganic material.

More specifically, the friction member 13 and the contact member 9 do not need atmospheric oxygen and moisture, making it possible to improve the abrasion resistance in a vacuum environment. Materials mainly composed of a nonmetal inorganic material include at least one of material groups of ceramics, cemented carbides, glasses, or cermets. Although cemented carbide uses cobalt or nickel as a bonding material, it is mainly composed of tungsten carbide and is included in materials mainly composed of a nonmetal inorganic material.

The motor performance and the abrasion resistance depend on the combination of the materials of the friction member 13 and the contact member 9. According to the consideration by the inventor, the motor performance and the abrasion resistance in vacuum are favorable when the friction material of the friction member 13 is cemented carbide, and the friction material of the contact member 9 is a ceramic of a titanium nitride compound.

Cemented carbide used as the friction member 13 is composed of tungsten carbide (about 92%), cobalt (about 8%), and other components (1% or less), having a Vickers hardness of HV1400 to HV1500. The composition of the cemented carbide is not limited to these values. The cemented carbide is composed of tungsten carbide (60% to 97%) and other components using cobalt or nickel as a bonding agent. The material of the friction member 13 may be mainly composed of cemented carbide and partly composed of a material other than cemented carbide.

The coating of a titanium nitride compound used for the contact member 9 is TiSiN having a Vickers hardness of HV3000 to HV3500. However, the titanium nitride compound is not limited to TiSiN but may be TiN or TiAlN. The base material of the contact member 9 is SUS304 or SUS420J2 as a stainless steel, cured by nitriding or hardening, and TiSiN is coated with PVD. This processing is intended to reduce the difference in hardness between the stainless steel as the base material and TiSiN as the coating to improve the adhesion. The underground of TiSiN may be coated to improve the adhesion. The base material needs to be a metal material that can be subjected to ceramic coating.

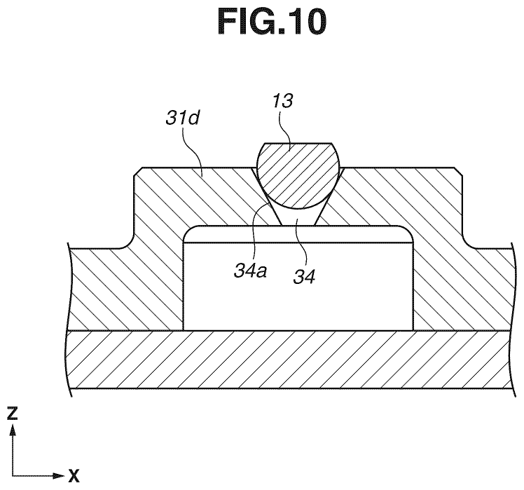

FIG. 10 is a cross-sectional view schematically illustrating a part of a first modification of the vibrating member 2 according to the present exemplary embodiment.

The present variation includes no cylindrical recessed portion. Only a first recessed portion 34 having a truncated cone shape is formed at the center of the disk portion 31d of the raised portion, and penetrates through the disk portion 31d. The friction member 13 comes into contact with the inclined surface 34a of the first recessed portion 34 and is fixed thereto by adhesion. The configuration of the present variation enables reducing the processing cost because of the simple shape of the recessed portion.

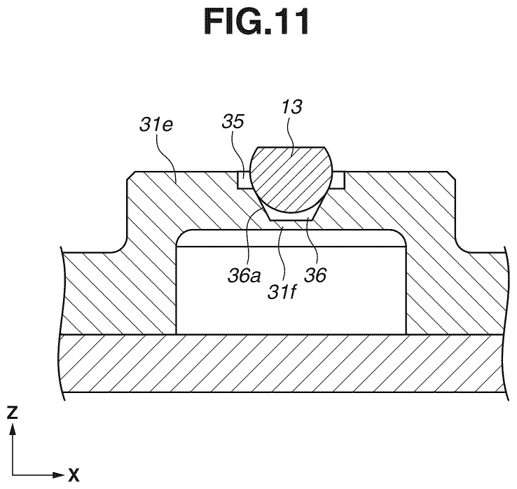

FIG. 11 is a cross-sectional view schematically illustrating a part of a second modification of the vibrating member 2 according to the present exemplary embodiment.

In the present variation, the recessed portion does not penetrate through the disk portion. A first recessed portion 35 having a cylindrical shape and a second recessed portion 36 having a truncated cone shape are formed at the center of a disk portion 31e of the raised portion. The second recessed portion 36 does not penetrate through the disk portion 31e but forms a bottom surface 31f. The friction member 13 comes into contact with the inclined surface 36a of the second recessed portion 36 and is fixed thereto by adhesion. Although FIG. 11 illustrates the bottom surface 31f having a linear shape, the bottom surface 31f may have a curved surface. Since the recessed portion does not penetrate through the disk portion 31e, the configuration of the present variation has a shape suitable for press working, making it possible to reduce the processing cost in mass production.

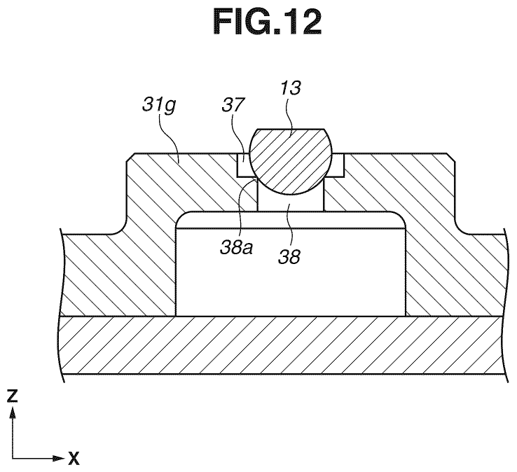

FIG. 12 is a cross-sectional view schematically illustrating a part of a third modification of the vibrating member 2 according to the present exemplary embodiment.

The present variation has two different recessed portions having a cylindrical shape. A first recessed portion 37 having a cylindrical shape and a second recessed portion 38 having a cylindrical shape and a smaller diameter than the first recessed portion 37 are formed at the center of a disk part 31g of the raised portion. A minute inclined surface 38a is formed on the ridge line between the first recessed portion 37 and the second recessed portion 38. The friction member 13 comes into contact with the inclined surface 38a and is fixed thereto by adhesion. More specifically, the configuration in FIG. 12 is implemented as the minute inclined surface 38a formed at the portion connecting the bottom surface of the first recessed portion 37 and the inner wall of the second recessed portion 38.

The inclined surface 38a may be formed by chamfering in machine processing (press working and cutting process). Alternatively, after a corner portion is formed in machine processing, the inclined surface 38a may be formed by bringing the friction member 13 into contact with the corner for flattening. The configuration of the present variation simplifies the process of forming the inclined surface 38a, reducing the processing cost.

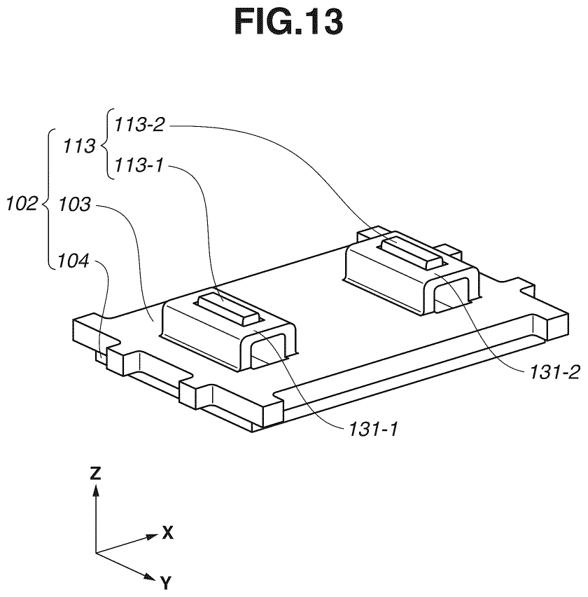

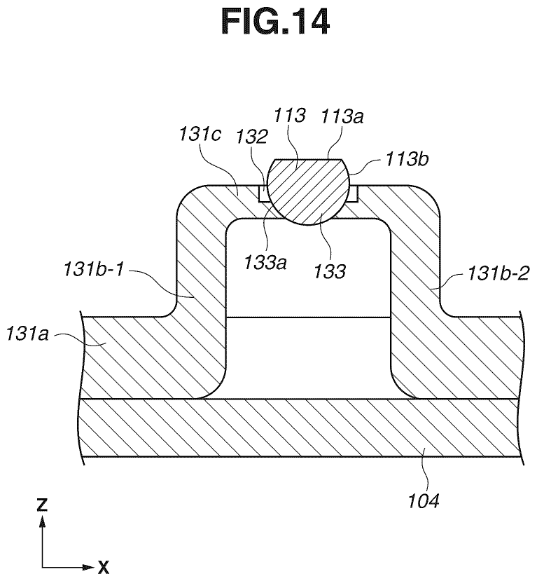

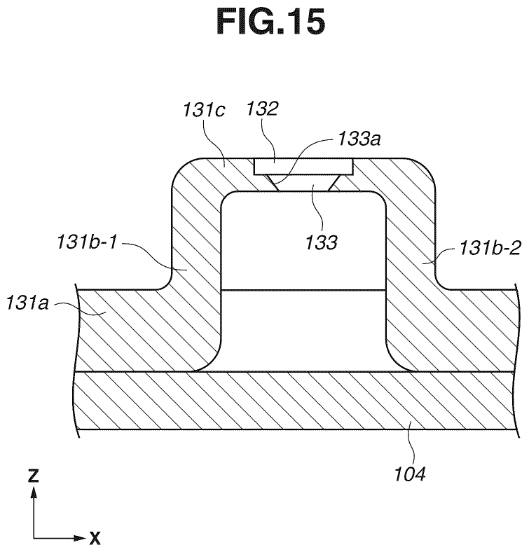

FIG. 13 is a perspective view schematically illustrating a fourth modification of the vibrating member 2 according to the present exemplary embodiment. FIG. 14 is a cross-sectional view schematically illustrating a part of the vibrating member 2 in FIG. 13. FIG. 15 is a cross-sectional view in which the friction member 13 is omitted in FIG. 14.

The present variation uses a friction member 113 having an approximately cylindrical shape. The friction member 113 is provided with a flat friction surface 113a formed by cutting a part of the cylindrical curved surface. Each of the raised portions 131 (131-1 and 131-2) is a hollow raised portion integrally formed with a flat portion 131a of the elastic member 3. The raised a structure portion 131 has supported at its opposite ends in which both edges in the Y direction are open, and a portal shape in which the parietal portion is supported by both edges. The raised portion 131 includes wall portions 131b (131b-1 and 131b-2) disposed in the X direction, and a rectangular plate 131c as the parietal portion where each edge is supported by the wall portions 131b. The rectangular plate 131c has a thickness providing a spring property of being deformed in the Z direction by a Z-directional load when in contact with the contact member 9. A first recessed portion 132 having a rectangular shape is formed at the center of the rectangular plate 131c in the X direction. A second recessed portion 133 is formed on the bottom surface of the first recessed portion 132 and penetrates through the rectangular plate 131c. The side walls of the second recessed portion 133 disposed in the X direction are inclined surfaces 133a having a width decreasing from the first recessed portion 132 along the Z direction. Each of the friction members 113 (113-1 and 113-2) having a cylindrical shape comes into contact with the inclined surfaces 133a in an approximately linear form on a curved surface 113b and bonded by adhesion. According to the configuration of the present variation, extending the friction members 113 in the Y direction increases the contact area to reduce the contact surface pressure, making it possible to improve the abrasion resistance.

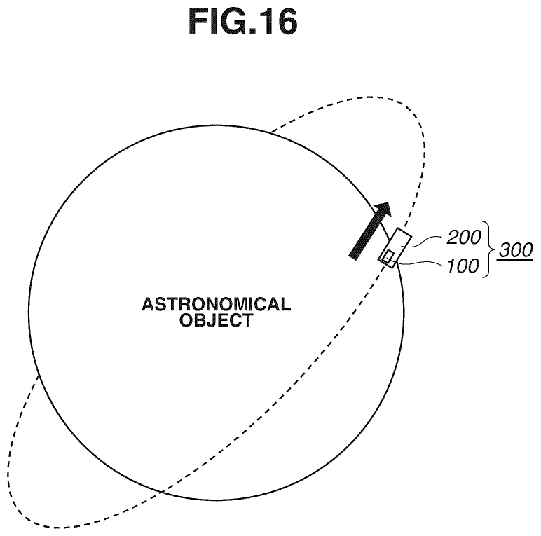

The vibratory actuator 100 according to the present exemplary embodiment achieves the improved abrasion resistance and stable driving in a vacuum environment. Therefore, the vibratory actuator 100 can be mounted on artificial satellites used in outer space and vacuum apparatuses used for production and analysis. For artificial satellites, for example, the vibratory actuator 100 can be used for linear and rotational drives of camera lenses, image sensors, and communication antennas. For vacuum apparatuses, the vibratory actuator 100 can be used for linear and rotational drives of members such as stages in vacuum chambers. FIG. 16 is a schematic view illustrating a moving object having an airframe mounted with the vibratory actuator 100. As illustrated in FIG. 16, the vibratory actuator 100 according to the present exemplary embodiment can be mounted on a moving object 300 orbiting the orbital track of an astronomical object (the size of the moving object 300 is emphasized for the sake of description). More specifically, the moving object 300 having an airframe 200 capable of navigating in outer space and the above-described vibratory actuator 100 can be used for the above-described diverse applications. In this case, the configuration of a control unit for controlling the airframe 200 and the vibratory actuator 100 is not particularly limited but can be arranged in a desired way according to applications. The control unit can be mounted on the airframe 200 or on the terrestrial part of an astronomical object such as the earth separately from the airframe 200. This makes it possible to configure a moving object control system including a moving object and a control unit for controlling the moving object.

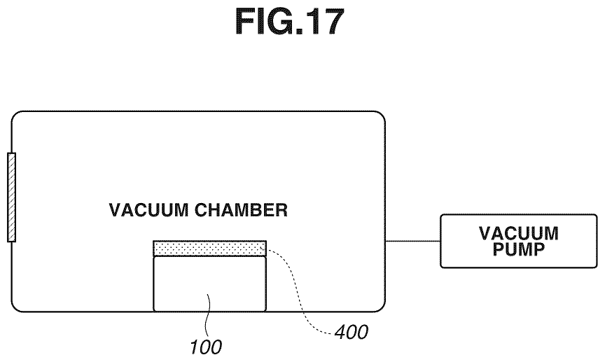

FIG. 17 is a schematic view illustrating a vacuum apparatus for driving a member in a vacuum chamber by using the vibratory actuator 100 of the present disclosure. The vacuum apparatus can drive a member 400 such as a stage in the vacuum chamber by using the vibratory actuator 100. This vacuum apparatus generates a vacuum state in the vacuum chamber isolated from the ambient air, by using a vacuum pump connected with the vacuum chamber. Under the vacuum environment, the member 400 can be driven by the vibratory actuator 100 of the present disclosure.

The present disclosure makes it possible to provide a vibratory actuator capable of improving the abrasion resistance to enable stable driving in a vacuum environment such as outer space and a vacuum apparatus.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Applications No. 2023-175146, filed Oct. 10, 2023, and No. 2024-124476, filed Jul. 31, 2024, which are hereby incorporated by reference herein in their entirety.

What is claimed is:

1. A vibratory actuator comprising:
a vibrating member having a rectangular elastic member and an electromechanical energy conversion element; and
a contact member in contact with the elastic member,
wherein the contact member and the vibrating member relatively move by a vibration of the vibrating member,
wherein a flat portion and a raised portion having a parietal portion and a wall portion are formed on the elastic member, where each edge or an entire circumference of the parietal portion is supported by the wall portion,
wherein the parietal portion is provided with a friction member, different from the elastic member, to come into contact with the contact member,
wherein the friction member is a sphere or column, and
wherein the friction member is supported by an inclined surface formed on the parietal portion.

2. The vibratory actuator according to claim 1, wherein the parietal portion is a disk, and the wall portion is a cylinder for supporting an outer circumference of the parietal portion.

3. The vibratory actuator according to claim 1, wherein the friction member is provided with a flat friction surface as a cut part of a curved surface of the friction member, the friction member being in contact with the contact member on the friction surface.

4. A vibratory actuator comprising:
a vibrating member having a rectangular elastic member and an electromechanical energy conversion element; and
a contact member in contact with the elastic member,
wherein the contact member and the vibrating member relatively move by a vibration of the vibrating member,
wherein a flat portion and a hollow raised portion are formed on the elastic member, and the parietal portion of the raised portion is provided with a friction member different from the elastic member, to come into contact with the contact member,
wherein the friction member is a sphere or column,
wherein the friction member contains a nonmetal inorganic material, and
wherein Vickers hardness of the friction member is higher than that of the elastic member.

5. The vibratory actuator according to claim 4, wherein the Vickers hardness of the friction member is at least twice that of the elastic member.

6. The vibratory actuator according to claim 4, wherein the Vickers hardness of the contact member is higher than that of the friction member.

7. The vibratory actuator according to claim 1, wherein the elastic member contains a nonmagnetic material.

8. The vibratory actuator according to claim 7, wherein the nonmagnetic material contains at least one material selected from aluminum alloys, brasses, and austenitic stainless steels.

9. The vibratory actuator according to claim 4, wherein the nonmetal inorganic material contains at least one type selected from a material group of ceramics, cemented carbides, glasses, and cermets.

10. The vibratory actuator according to claim 1, wherein a raised portion having the parietal portion and the wall portion is integrally formed.

11. The vibratory actuator according to claim 1, wherein a material of the friction member contains cemented carbide, and a material of the contact member contains a metal material coated with a titanium nitride compound.

12. The vibratory actuator according to claim 11, wherein the titanium nitride compound is TiSiN.

13. The vibratory actuator according to claim 1, wherein the vibratory actuator operates in a vacuum environment.

14. A moving object comprising:
an airframe configured to navigate in outer space; and
the vibratory actuator according to claim 1.

15. A moving object control system comprising:
the moving object according to claim 14; and
a control unit of the moving object.

16. A vacuum apparatus comprising:
a vacuum chamber;
a vacuum pump configured to be connected with the vacuum chamber; and
the vibratory actuator according to claim 1.
